(19) United States
(12) Patent Application Publication
(10) Pub. No.: US 2016/0116327 A1
(43) Pub. Date: Apr. 28, 2016

(54) SCALING SYSTEM

(71) Applicant: LaTanya McCaskill, El Dorado Hills, CA (US)

(72) Inventor: LaTanya McCaskill, El Dorado Hills, CA (US)

(21) Appl. No.: 14/520,554

(22) Filed: Oct. 22, 2014

(51) Int. Cl. G01G 21/22

(52) U.S. Cl. CPC G01G 21/22

(57) ABSTRACT

A scaling system includes an electronic scale having a flat flexible body. The device includes a pressure sensor disposed within the flat flexible body. The pressure sensor generates a pressure signal. The device also includes a wireless communication module to transmit at least one of the pressure signal or a weight measurement based on the pressure signal. The scaling system also includes a computing device wirelessly coupled to the electronic scale device. The computing device receives at least one of the pressure signal or the weight measurement from the electronic scale device.

### FIELD OF THE INVENTION

The present invention relates to a scaling system, and in particular, to an electronic scale device in communication with a remote computing device to provide a weight of an object.

### BACKGROUND OF THE INVENTION

Increasing regulations of both commercial shipping and personal travel, particularly by airplane, require determination of a weight of a luggage in order to travel.

Many conventional electronic scales exist today that measure weight of the luggage. Such conventional electronic scales come in all shapes and sizes, though few are portable. Even the portable scales are generally quite heavy to carry, which is especially problematic for the elderly, infirmed, and physically challenged. In addition, it is commonly difficult to read data on most of the conventional electronic scales.

### BRIEF DESCRIPTION OF THE DRAWINGS

FIG. 1A is a perspective view of an electronic scale device in accordance with one embodiment of the present invention;

FIGS. 1B, 1C and 1D illustrate views of folding of the electronic scale device of FIG. 1A in accordance with an embodiment of the present invention;

FIG. 2 illustrates a section 3-3 view of the housing of the electronic scale device of FIG. 1A in accordance with an embodiment of the present invention;

FIG. 3 illustrates a system block diagram of a pressure detection module in the housing of the electronic scale device of FIG. 2 according to an embodiment of the present invention;

FIG. 4 illustrates a system block diagram of a pressure detection module in the housing of the electronic scale device of FIG. 2 according to another embodiment of the present invention.

FIG. 5 illustrates a remote computer system in communication with the electronic scale device of FIG. 1A in accordance with an embodiment of the present invention.

FIG. 6 is a flow chart illustrating a method for providing a weight of an object in accordance with an embodiment of the present invention.

### DETAILED DESCRIPTION OF THE INVENTION

Accordingly, embodiments of the present invention provide a scaling system that has minimal weight and provides for remote digital reading of a weight data of an object. In one embodiment, the scaling system includes an electronic scale device, which is flexible, lightweight, and stowable. The scaling system also includes a remote computing device in communication with the electronic scale device to generate and display weight data of an object placed on the electronic scale device.

The scaling system of the present invention provides several advantages. One such advantage is being that the electronic scale device is both lightweight and flexible which makes it easier to lift, fold it in a compact configuration to be stored in a container such as a luggage. Another advantage is that the electronic scale device is portable such that an object, such as a luggage, may be easily placed on it without requiring a user to lift the entire luggage onto the electronic scale device. Further, the electronic scale device communicates wirelessly with a computing device, such as a smartphone, laptop, desktop or other computing devices to display weight of the object. As such, the scaling system is adaptable to various user needs and locations.

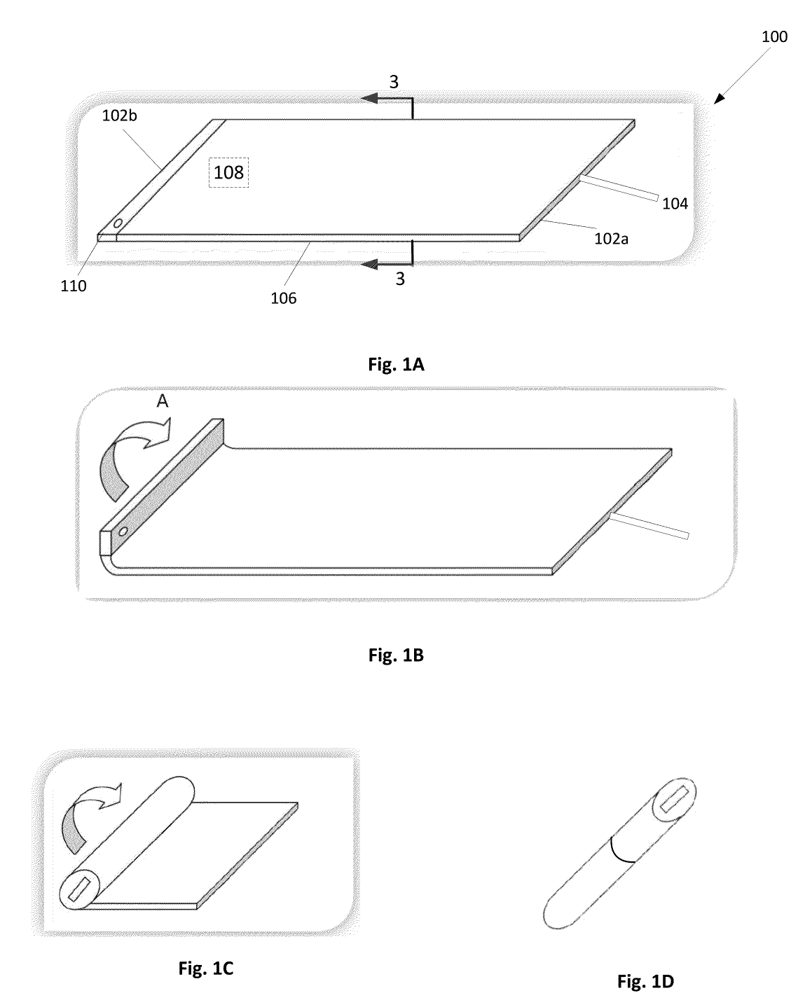

Referring to FIG. 1A, there is illustrated a schematic view of an electronic scale device 100 of the present invention that can communicate with computing devices as illustrated and will be described. More particularly, the electronic scale device (a.k.a. “device”) 100 having a substantially flat planar surface 102 (when rolled out onto a surface that is substantially flat) and is made of flexible resistant material such as plastics, rubbers, ceramics, composites etc. The device 100 may conform to other surfaces that it is placed on, and so may also have a non-flat surface in some instances. In one embodiment, the device 100 is approximately 30 cm in length, approximately 30 cm in width, approximately 0.5 cm thick and weighs in the range of 2.5 pounds to 3.5 pounds. However, the device 100 may have other dimensions and weights as well. For example, the device 100 could have dimensions including but not limited to 60×90 cm. As an example, the device 100 may be a soft rubber mat or a carpet rug. In one embodiment, an object (not shown) may be placed on the surface 102 of the device 100. The object (not shown) may include wheels such that the object may be rolled onto the surface 102 of the device without much force or pressure.

In one embodiment, the device 100 can be easily rolled or folded into a compact configuration for storage as shown in FIGS. 1B, 1C, and 1D. Specifically, the surface 102 has a first end 102a and a second end 102b opposite the first end. The first end 102a may include at least one strap 104 made of a flexible material such as plastic, cloth, fabric, etc. The strap 104 may include a fastener (not shown). As an example, the strap 104 may include a male or female hook and loop (e.g., Velcro®) fastener, and another strap or a backside of the device 100 may include the opposite female or male hook and loop fastener. Other types of fasteners such as clasps, magnets, buckles, etc. may be used. Even though the device 100 as shown includes only one fastener 104, one of ordinary skill in the art can appreciate that device 100 may include multiple fasteners. FIG. 1B shows the device 100 after the second end 102b has been lifted. FIG. 1C shows the device 100 in a partially rolled configuration, and FIG. 1D shows the device 100 in a fully rolled configuration. As shown, the device 10 may be folded or rolled starting from the second end 102b in a direction of arrow A towards the first end 102a until the first end 102a is wrapped about the second end 102b. Once the device 100 is fully folded or rolled, the fastener on strap 104 may be engaged to retain the device 100 in the folded or rolled position.

Referring back to FIG. 1A, the device 100 includes a housing 106 that houses internal components and frames the surface 102 such that the surface 102 is exposed for user interaction when the device 100 is in use. The housing 106 may be embedded within the device 100, and may not be visible at an exterior of the device 100. For example, the housing 106 may be embedded within the flexible body of the device 100 (e.g., within the rubber or plastic body of the device). In one embodiment, the internal components may be powered via a common rechargeable scale battery (not shown) placed within the housing 106. In another embodiment, the internal components may be powered via an electric connector (not shown) placed within the housing 106 for using an external power supply (e.g., for plugging into an electrical outlet). The surface 102 of the device 100 may include a display 108 to display a weight data associated with an object, or may not include a display.

The device 100 may also include physical switches for controlling the device 100. In the present example, the device 100 includes one on/off switch (hereinafter “switch”) 110 on top of the surface 102. Alternatively, the device 100 may include a sensor (e.g., a capacitive sensor, proximity sensor, a light sensor, etc.) that is positioned in a manner to detect when the device 100 is rolled up or folded. The sensor may cause the device 100 to automatically turn on when it detects that the device is not folded or rolled up, and may cause the device 100 to automatically turn off when it is folded or rolled up. In one embodiment, the switch for performing functions on the device 100 may be virtual features, rendered on the surface 102.

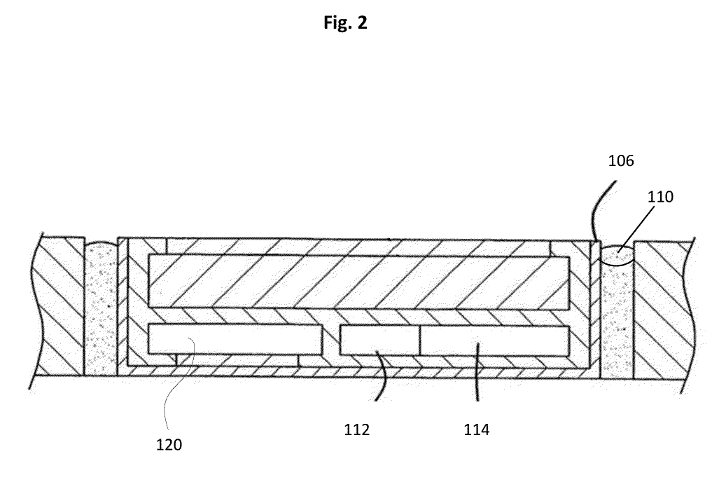

FIG. 2 illustrates a sectional view of the housing 106 of the device 100 in accordance with an embodiment of the present invention. In one embodiment, an interface module 112 is securely placed within the housing 106 and is electrically communicable with the switch 110 and/or sensor (not shown). The interface module 112 may include visual display or output, such as one or more lights, light emitting diodes (LEDs), liquid crystal displays (LCDs), and so on. In one embodiment, the switch 110 is communicable with the interface module 112 such that upon pressing of the switch 110, the interface module 112 may cause the lights to flash in different pre-defined patterns corresponding to turning on or off the device 100.

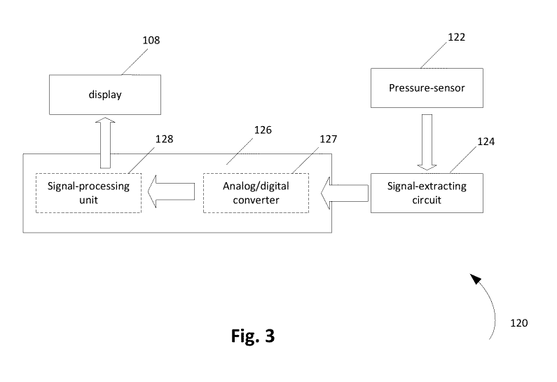

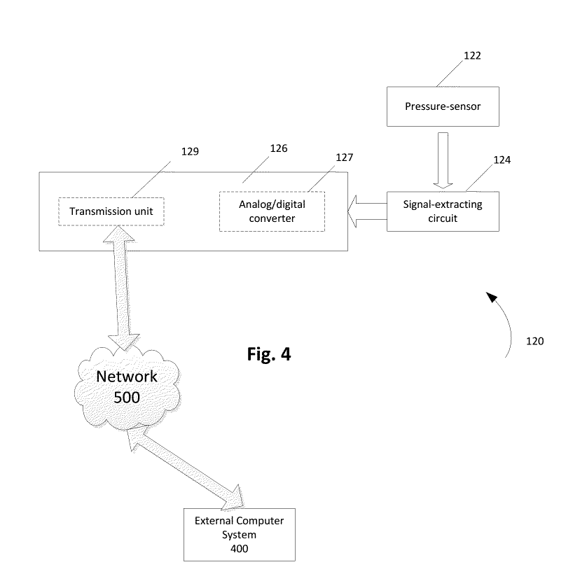

In one embodiment, the device 100 may also include a pressure detection module 120 securely placed within the housing 106 to generate pressure signals based on a weight applied by an object (not shown) placed on the surface 102 and further process the pressure signals. The pressure detection module 120 may include pressure detectors that extend throughout the length and width of the device 100. Alternatively, the pressure detectors may be in one or a few regions of the device 100. Details of the pressure detection module 120 are described below with respect to FIGS. 3 and 4 below.

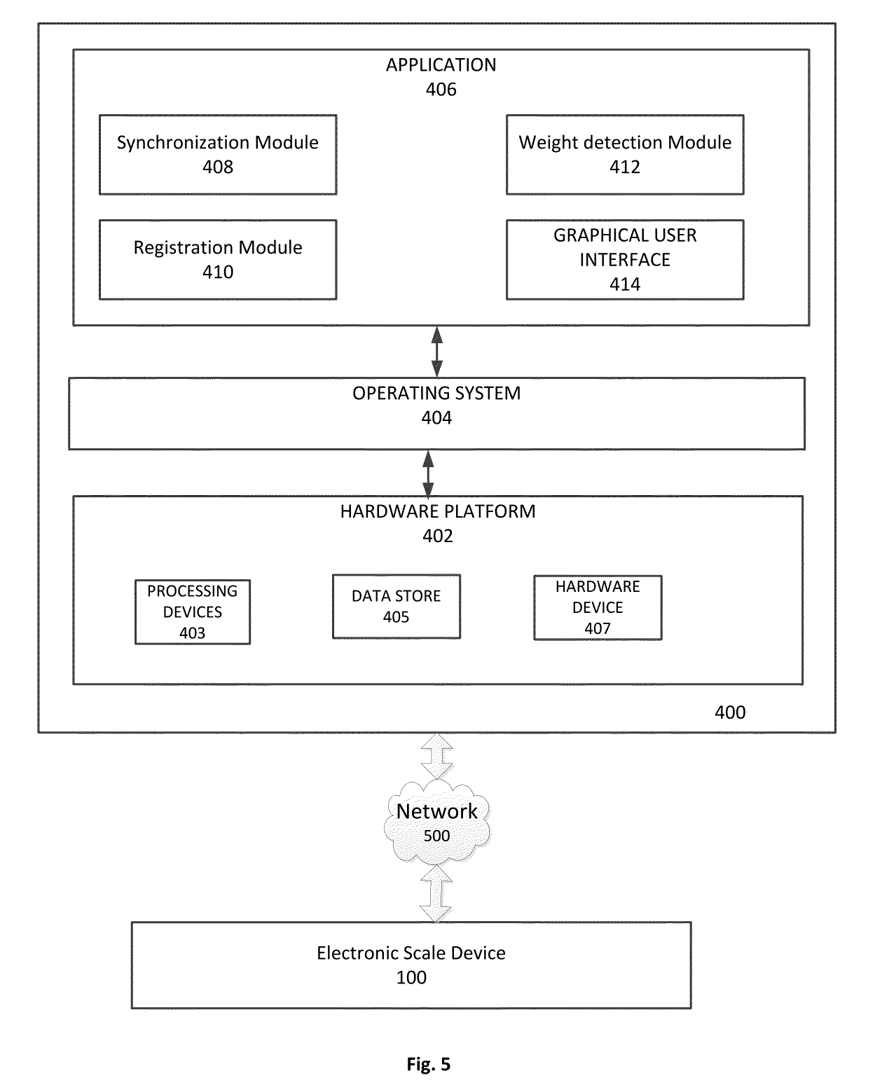

A communication module 114 may also be disposed within the housing 106, and may be electrically communicable with the switch 110. Upon pressing of the switch 110, the communication module 114 may transmit a communication signal to communicate with an external computer system 400 to synchronize the device 100 and/or transmit information, as will be described in detail with respect to FIG. 5 below.

FIG. 3 illustrates a system block diagram of a pressure detection module 120 according to one embodiment of the present invention. The pressure detection module 120 may include at least a pressure sensor 122, a signal-extracting circuit 124, and a controller 126. In one embodiment, the pressure sensor 122 is a pressure sensitive gravitational sensor including electric coils suspended by springs. In another embodiment, the pressure sensor 122 is a pressure sensitive gravitational sensor including optical fiber coils. Any other type of pressure sensor 122 may also be utilized that has a low (relatively flat) profile that can fit into device 100. Another pressure sensor that might be used includes force sensitive resistors (FSR) that change resistance based on an applied force. Another example pressure sensor is a micro-electrical-mechanical system (MEMS)-based piezoresistive pressure sensor. In one embodiment, the pressure sensor 122 has a thickness of not greater than 1 cm.

As the object (not shown) is placed on the surface 102 of the device 100, the pressure sensor 122 generates pressure signals, which are extracted by a signal-extracting circuit 124. Alternatively, pressure sensors 122 may generate signals that are usable without a signal extracting circuit 124. The signal-extracting circuit 124 transmits the pressure signals to the controller 126, which functions to process the pressure signals to generate the weight data of the object. In one embodiment, the controller 126 conducts signal processing to generate weight data of the object. In one embodiment, the controller 26 includes an analog/digital converter 127 and a signal-processing unit 128. The analog/digital converter 127 is configured to convert an analog signal of the pressure signals generated by the pressure sensor 122 into digital pressure signals, and the signal-processing unit 128 (such as a microprocessor) is configured to generate measurement results from the digital pressure signals. Specifically, the signal-processing unit 128 calculates the weight data from digital pressure signals and transmits the weight data to the display 108. In alternative embodiments, one or more of the analog to digital converter 127 and/or signal processing unit 128 may be omitted. For example, some pressure sensors 122 output digital data. For such pressure sensors, an analog to digital converter may be omitted.

FIG. 4 illustrates a system block diagram of a pressure detection module 120 according to another embodiment of the present invention. The pressure detection module 120 of FIG. 4 is similar to the pressure detection module 120 in FIG. 3, except the controller 24 does not include the signal processing unit 128 and instead includes a transmission unit 130. In one embodiment, the transmission unit 130 includes a wired network interface controller to allow the device 100 to communicate via a wired network (e.g. Ethernet ports, universal serial bus (USB) ports and/or Firewire® ports) with other computing devices, such as remote computers, the server systems, and so forth. In one embodiment, the transmission unit 130 includes a wireless network interface controller (WNIC) to allow the device 100 to communicate via a wireless network (e.g., such as provided by the wireless communication systems) with other computing devices, such as remote computers, the server systems, and so forth. The WNIC may be a Wi-Fi module, a Bluetooth module, a near filed communication (NIC), a Zigbee or other wireless modules or devices.

The transmission unit 130 transmits the digital pressure signals to the external computer system 400 via a network 500 for performing the signal processing to calculate weight data and display the weight data as described in further detail below. Alternatively, pressure detection module 120 may include a signal processing unit 128 that processes the pressure sensor signals prior to transmitting to the external computer system 400. The external computer system 400 may be a desktop computer, a laptop computer, a mobile phone, a tablet computer, an electronic book reader, a portable game console, or other computing device.

FIG. 5 illustrates the external computer system 400 in communication with the electronic scale device 100 according to an embodiment of the present invention. The external computer system 400 may be any variety of user devices such as a personal computer (PC), a laptop, a mobile phone, a tablet computer, handheld devices, netbooks, or any other computing device. Furthermore, the external computer system 400 may include a server device, such as a mainframe server device or any other type of server device. The external computer system 400 may include a hardware platform 402, on top of which runs an operating system (OS) 404 for managing operations on the external computer system 400. The OS 404 may include Windows™, Linux™, Solaris™, OS X™ iOS™, Android™ OS, or any other suitable OS for managing operations on the external computer system 400.

The hardware platform 402 may include one or more processing devices 403 and a data store 405. The processing devices 403 may be central processing devices (CPUs), microprocessors, and so forth. In one embodiment, the data store 405 includes one or more hardware or software devices, which may be located internally or externally to the computer system 400. Examples of data store 405 may include, but are not limited to, random-access memory (RAM), non-volatile storage memory (e.g., Flash, EEPROM, solid state drives (SSD), etc.), magnetic storage memory (e.g., one or more hard drives), and optical memory (e.g., CDs, DVD, BlueRay drives, etc.). In addition, the hardware platform 402 may include additional hardware devices 407, such as network interface cards (NICs), sound or video adaptors, photo/video cameras, printer devices, displays, input devices such as keyboards, mouse, touch screens or any other suitable device intended to be coupled to a computer system.

The computer system 400 may include a software application program 406 (i.e. application) executed by the OS 404. The application 406 may include any computer-executable program capable of communicating with the OS 404. Although, only one application 406 is shown, one of ordinary skill in the art can appreciate that device 100 may include multiple applications. The applications may include, but are not limited to, voice mail applications, web applications, games, and/or other applications.

In one embodiment, the communication module 114 and the pressure detection module 120 of the device 100 may communicate with the computer system 400 via the network 500. The network 500 may be any type of communication network including, but not limited to, a local area network (LAN), a wide area network (WAN) (e.g., the Internet,) or similar communications network. The network 500 can include any number of network devices and computing devices that are in communication over any combination of wired and wireless communication lines.

In one embodiment, the application 406 includes a synchronization module 408, which receives the communication signal from the communication module 114 of the device 100. Upon receipt of the communication signal, the synchronization module 408 synchronizes the device 100 with the OS 404 in order to communicate with the computer system 400. As such, the device 100 is paired with the computer system. Upon the synchronization, the application 406 further sends a synchronization signal back to the communication module 114 of the device 100 indicating that the device 100 is synchronized. Upon receipt of the synchronization signal, the communication module 114 communicates with the switch 110 indicating that the device 100 is ready to be used. Upon receipt of this communication, the interface module 112 may cause a light on the electronic scale device 100 to stop flashing and remain in a constant or solid position, which indicates to a user that the device 100 is ready to be used with the external computer system 400.

In one embodiment, the application 406 includes a registration module 410, which allows one or more users to register with the device 100. Upon synchronization of the device 100, a user is provided with instructions via a graphical user interface (GUI) 414 to register with the device 100. In one embodiment, the instructions are provided on a display of the hardware device 407. A user may register with the device 100 via an input device of the hardware device 407. In one embodiment, the registration module 410 generates an identifier (ID) and provides the identifier (ID) to the user via the display on the hardware device 407. In one embodiment, the ID uniquely identifies the user. In one example, three users may be allowed to register with the device 100, thus three IDs may be generated and provided to each of the three users. In one embodiment, the IDs are stored in the data store 405.

In one embodiment, the application 406 includes a weight detection module 412, which receives the digital pressure signal from the transmission unit 129 of the pressure detection module 120 of FIG. 4 via the network 500. As discussed above, the digital pressure signals are generated by the pressure detection module 120 upon placement of the object on the surface 202 of the device 100. As an example, the object is luggage, which is associated with a travel itinerary of the user provided in a user profile. The user profile may be stored in the data store 405. As such, the user may select luggage from the user profile and place it on the surface 202 of the device 100. The weight detection module 412 functions to generate measurement results from the digital pressure signals to calculate the weight data. In one embodiment, the weight data is displayed to the user via the GUI 414. The weight data is provided on a display of the hardware device 407.

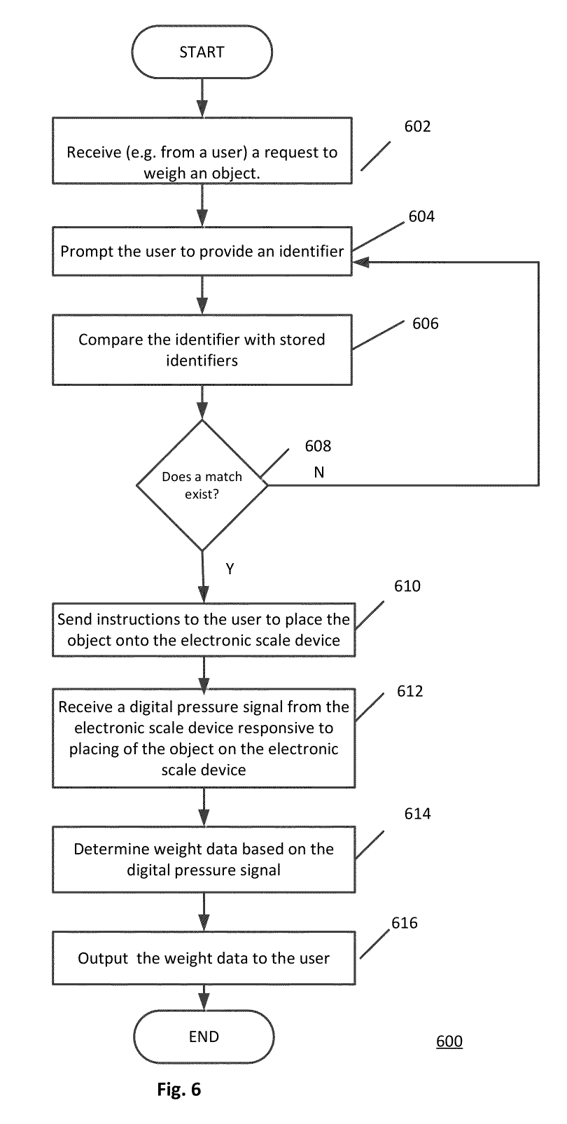

FIG. 6 is a flow chart illustrating a method 600 of determining a weight of an object in accordance with an embodiment of the present invention. Method 600 may be performed by processing logic that may comprise hardware (e.g., circuitry, dedicated logic, programmable logic, microcode, etc.), software (such as instructions run on a processing device), firmware, or a combination thereof. In one embodiment, the method 600 is performed by the registration module 410 and the weight detection module 414 of FIG. 5 executing in a computing device, such as the external computer system 400 of FIG. 5.

The method 600 begins at block 602, where a request to weigh an object is received (e.g., from a user). In one embodiment, the request is received by the user of the computing device. At block 604, a user is prompted to provide an identifier (ID). As discussed above, the ID uniquely identifies the user. At block 606, the ID is compared with one or more stored IDs. At block 608, it is determined whether a match exists between the ID provided by the user and one of the stored IDs. At block 610, instructions are sent to a user to place the object onto an electronic scale device when the match is determined to exist at block 608. In one embodiment, the electronic scale device is the same as the electronic scale device 100 of FIG. 1.

At block 612, a digital pressure signal is received from the electronic scale device responsive to placing of the object on the electronic scale device. At block 614, weight data is determined based on the digital pressure signal. As discussed above, measurement results are generated from the digital pressure signals to calculate the weight data. At block 616, the weight data is outputted to the user. In one embodiment, the weight data is displayed on a display of the hardware device 407 of FIG. 5. The weight data may also be stored. Returning back to block 608, when it is determined that the identification code provided by the user does not match with one of the stored identification codes, then block 604 is again executed.

The modules, components and other features described herein (for example in relation to FIGS. 1-2) can be implemented as discrete hardware components or integrated in the functionality of hardware components such as ASICS, FPGAs, DSPs or similar devices. In addition, the modules can be implemented as firmware or functional circuitry within hardware devices. Further, the modules can be implemented in any combination of hardware devices and software components, or only in software.

In the foregoing description, numerous details are set forth. It should be apparent, however, that the disclosure may be practiced without these specific details. In some instances, structures and devices are shown in block diagram form, rather than in detail, in order to avoid obscuring the disclosure.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “determining”, “generating”, “receiving”, “pairing”, “prompting”, “outputting”, “displaying”, “storing” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the discussed purposes, or it may comprise a general purpose computer system selectively programmed by a computer program stored in the computer system. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

It is to be understood that the above description is intended to be illustrative, and not restrictive. Many other embodiments will be apparent to those well-known in the art upon reading and understanding the above description. Although the disclosure has been described with reference to specific examples of embodiments, it will be recognized that the disclosure is not limited to the embodiments described, but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. An electronic scale device comprising:
a mat having a flat flexible body, wherein the mat comprises a bottom surface and an upper surface for placement of an object; and
a pressure sensor disposed within the flat flexible body, the pressure sensor to generate a pressure signal.

2. The electronic scale device of claim 1 wherein the body has dimensions of at least 30 cm of length, at least 30 cm of width and a thickness of at least 0.5 cm of thickness, wherein the mat weighs at least 2.5 pounds.

3. The electronic scale device of claim 1 wherein the mat is foldable.

4. The electronic scale device of claim 1 further comprises at least one strap secured to the mat.

5. The electronic scale device of claim 4 wherein the at least one strap is engaged to the mat upon folding of the mat to retain the mat in a folded position.

6. The electronic scale device of claim 4 wherein the at least one strap is disengaged from the mat to place the mat in an unfolded position.

7. The electronic scale device of claim 1 wherein the mat comprises a display to illustrate a weight measurement based on the pressure signal.

8. The electronic scale device of claim 1 further comprising a wireless communication module disposed within the flat flexible body, wherein the wireless communication module is coupled the pressure sensor to transmit at least one of the pressure signal or a weight measurement based on the pressure signal.

9. The electronic scale device of claim 8 wherein the wireless communication module transmits one of the pressure signal or a weight measurement based on the pressure signal to a computing device external to the device.

10. A system comprising:
an electronic scale device comprising:
a flat flexible body;
a pressure sensor disposed within the flat flexible body, the pressure sensor to generate a pressure signal; and
a wireless communication module to transmit at least one of the pressure signal or a weight measurement based on the pressure signal; and
a computing device wirelessly coupled to the electronic scale device, wherein the computing device is to receive at least one of the pressure signal or the weight measurement from the electronic scale device.

11. The system of claim 10 wherein the computing device comprises a weight detection module to generate the weight measurement based on the pressure signal.

12. The system of claim 10 wherein the computing device comprises a display to display the weight measurement.

13. The system of claim 10 wherein the computing device comprises a registration module to register a user of the computing device with the electronic scale device.

14. The system of claim 13 wherein the registration of the user comprises providing a unique identifier to a user.

15. The system of claim 10 wherein the computing device comprises a synchronization module to synchronize the electronic scale device with the computing device.

16. The system of claim 10 wherein the electronic scale device is foldable.

17. The system of claim 10 wherein the body has dimensions at least 30 cm of length, at least 30 cm of width and a thickness of at least 0.5 cm of thickness, wherein the mat weighs at least 2.5 pounds.

18. A method comprising:
pairing a computing device to an electronic scale device;
prompting, by the computing device, a user to place an object to be weighed on the electronic scale device;
receiving, by the computing device, pressure signals, wherein the pressure signals are generated by placement of the object on a surface of the electronic scale device; and
generating, by the computing device, weight data based on the pressure signals; and
outputting the weight data by the computing device.

19. The method of claim 18 wherein the weight data is displayed on the computing device.

20. The method of claim 19 further comprising receiving a request from a user to weigh the object.
